(19) United States
(12) Patent Application Publication
(10) Pub. No.: US 2022/0342226 A1
(43) Pub. Date: Oct. 27, 2022

(54) Beam Splitter Plate, Beam Splitter Apparatus, Beam Splitter Lens Module, Camera, and Electronic Device

(71) Applicant: Huawei Technologies Co., Ltd., Shenzhen (CN)

(72) Inventors: Jun Liu, Dongguan (CN); Yong Chen, Dongguan (CN); Can Li, Dongguan (CN); Mingxuan Li, Dongguan (CN)

(21) Appl. No.: 17/862,800

(22) Filed: Jul. 12, 2022

Related U.S. Application Data
(63) Continuation of application No. PCT/CN2020/118581, filed on Sep. 28, 2020.

(30) Foreign Application Priority Data
Jan. 14, 2020 (CN) 202010036850.2
Mar. 27, 2020 (CN) 202010235860.9

(51) Int. Cl. G02B 27/10; G02B 27/18; G02B 5/28; G02B 13/14; G02B 1/11

(52) U.S. Cl. CPC G02B 27/1006; G02B 27/18; G02B 5/282; G02B 13/14; G02B 1/11

(57) ABSTRACT

A beam splitter plate configured to dispose obliquely in a transmission path of an imaging beam of a camera and comprising a transmissive plate, and a beam splitter film supported on the transmissive plate and parallel to the transmissive plate, wherein the beam splitter film is configured to reflect visible light and transmit near-infrared light, or the beam splitter film is configured to reflect the near-infrared light and transmit the visible light, wherein a thickness of the transmissive plate satisfies that transmission path lengths of the visible light and the near-infrared light in the imaging beam in the transmissive plate are both less than a projection length of the beam splitter film on an optical axis of the imaging beam.

### CROSS-REFERENCE TO RELATED APPLICATIONS

This is a continuation of International Patent Application No. PCT/CN2020/118581 filed on Sep. 28, 2020, which claims priority to Chinese Patent Application No. 202010036850.2 filed on Jan. 14, 2020 and Chinese Patent Application No. 202010235860.9 filed on Mar. 27, 2020. All of the aforementioned applications are hereby incorporated by reference in their entireties.

### TECHNICAL FIELD

This application relates to the field of electronic device technologies, and in particular, to a beam splitter plate, a beam splitter apparatus, a beam splitter lens module, a camera, and an electronic device.

### BACKGROUND

Low-illumination cameras are widely applied to military, security protection, public safety, and other fields because they can still capture clear images under low-illumination conditions.

Currently, most low-illumination cameras need to use an infrared lamp to supplement light in a low-illumination scenario such that scene brightness can be improved. However, after the infrared lamp is used to supplement light, light collected by the camera includes visible light and near-infrared light. Wavelengths of the visible light and the near-infrared light differ greatly. If the two are mixed together, a captured image is subjected to a severe color cast. To enable the low-illumination camera to output a color image with realistic colors, a beam splitter structure may be added to a transmission path of an imaging beam of the low-illumination camera, to split an imaging beam formed by focusing by an imaging lens module into visible light and near-infrared light such that the visible light and the near-infrared light can be separately processed and then fused. In this way, the low-illumination camera can output a color image with realistic colors. However, in the low-illumination camera, the addition of the beam splitter structure inevitably introduces a chromatic aberration and an off-axis aberration. To ensure quality of the color image output by the low-illumination camera, a parameter of another optical structure (such as the imaging lens module) in an imaging beam path needs to be changed to balance the chromatic aberration and the off-axis aberration, so as to minimize an overall chromatic aberration and off-axis aberration caused by structures in the imaging beam path of the camera. Moreover, a larger chromatic aberration and off-axis aberration introduced by the beam splitter structure indicate greater difficulty in adjusting the parameter of the other optical structure, and greater difficulty in correcting the chromatic aberration and the off-axis aberration of the camera.

### SUMMARY

Embodiments of this application provide a beam splitter plate, a beam splitter apparatus, a beam splitter lens module, a camera, and an electronic device to reduce a chromatic aberration and an off-axis aberration introduced by a beam splitter structure, and reduce difficulty in correcting a chromatic aberration and an off-axis aberration of a camera.

To achieve the foregoing objective, the following technical solutions are used in the embodiments of this application.

According to a first aspect, some embodiments of this application provide a beam splitter plate, disposed obliquely in an imaging beam path of a camera. The beam splitter plate includes a transmissive plate and a beam splitter film. The transmissive plate is a light-transmitting plate-like structure. The beam splitter film is supported on the transmissive plate and is parallel to the transmissive plate. The beam splitter film is configured to reflect visible light and transmit near-infrared light, or the beam splitter film is configured to reflect near-infrared light and transmit visible light. A thickness of the transmissive plate satisfies that when the beam splitter plate is disposed obliquely in a transmission path of an imaging beam of the camera, transmission path lengths of visible light and near-infrared light in the imaging beam in the transmissive plate are both less than a projection length of the beam splitter film on an optical axis of the imaging beam.

In the beam splitter plate provided in this embodiment of this application, because the beam splitter film is configured to reflect visible light and transmit near-infrared light, or the beam splitter film is configured to reflect near-infrared light and transmit visible light, visible light and near-infrared light in the imaging beam path can be separated by using the beam splitter film. Moreover, the beam splitter film is supported on the transmissive plate and is parallel to the transmissive plate, and the thickness of the transmissive plate satisfies that when the beam splitter plate is disposed obliquely in the transmission path of the imaging beam of the camera, the transmission path lengths of the visible light and the near-infrared light in the imaging beam in the transmissive plate are both less than the projection length of the beam splitter film on the optical axis of the imaging beam. Assuming that an inclination angle of the beam splitter plate is θ, and a width of the beam splitter film along an inclination direction of the beam splitter plate is L, the projection length of the beam splitter film on the optical axis of the imaging beam is L×cos θ. When the beam splitter film is disposed at the same inclination angle in the transmission path of the imaging beam and supported by two right angle prisms, transmission path lengths of the visible light and the near-infrared light in the imaging beam in the two right angle prisms are L₀₁ and L₀₂, respectively, L₀₁=L₀₂, and L₀₁ and L₀₂ are both equal to L×cos θ. It can be learned from above that the transmission path lengths of the visible light and the near-infrared light in the imaging beam are both less than L₀₁ or L₀₂. When a material used for the beam splitter plate is the same as a material of the two right angle prisms, the visible light and the near-infrared light in the imaging beam have relatively short optical paths when transmitted in the transmissive plate, which causes a relatively small chromatic aberration and off-axis aberration, and helps reduce difficulty in correcting a chromatic aberration and an off-axis aberration of the camera.

Optionally, the thickness of the transmissive plate is less than 0.5 millimeter (mm). In this way, the thickness of the transmissive plate is relatively small, and when the beam splitter plate is disposed obliquely in the transmission path of the imaging beam of the camera, the transmission path lengths of the visible light and the near-infrared light in the imaging beam in the transmissive plate are relatively small, which causes a relatively small chromatic aberration and off-axis aberration, and reduces difficulty in correcting a chromatic aberration and an off-axis aberration of the camera.

Optionally, the transmissive plate has a first surface and a second surface opposite to each other, and the beam splitter film is attached to the first surface or the second surface. The structure is simple and is easy to implement.

Optionally, when the beam splitter film is attached to the first surface, and the beam splitter film is configured to reflect near-infrared light and transmit visible light, the beam splitter plate further includes a first antireflective film. The first antireflective film is attached to the second surface, and the first antireflective film is configured to increase a transmittance of visible light emergent out of the transmissive plate from the second surface. When the beam splitter film is attached to the first surface, and the beam splitter film is configured to reflect visible light and transmit near-infrared light, the beam splitter plate further includes a second antireflective film. The second antireflective film is attached to the second surface, and the second antireflective film is configured to increase a transmittance of near-infrared light emergent out of the transmissive plate from the second surface. In this way, the transmittance, at the second surface, of the visible light or the near-infrared light transmitted by the beam splitter film is increased by using the first antireflective film or the second antireflective film, and an optical path loss is reduced.

Optionally, when the beam splitter film is attached to the second surface, the beam splitter plate further includes a third antireflective film. The third antireflective film is attached to the first surface, and the third antireflective film is configured to increase transmittances of visible light and near-infrared light that are incident into the transmissive plate from the first surface. In this way, the transmittances of the visible light and the near-infrared light that are incident into the beam splitter plate are increased by using the third antireflective film, and an optical path loss is reduced.

Optionally, the transmissive plate includes a first transmissive plate and a second transmissive plate. The first transmissive plate has a first surface and a second surface opposite to each other. The second transmissive plate has a first surface and a second surface opposite to each other. The beam splitter film is sandwiched between the second surface of the first transmissive plate and the first surface of the second transmissive plate. The structure is simple and easy to implement, and can perform waterproof and dustproof protection on the beam splitter film.

Optionally, the beam splitter plate further includes a fourth antireflective film. The fourth antireflective film is attached to the first surface of the first transmissive plate, and the fourth antireflective film is configured to increase transmittances of visible light and near-infrared light that are incident into the first transmissive plate from the first surface of the first transmissive plate. In this way, the transmittances of the visible light and the near-infrared light that are incident into the beam splitter plate are increased by using the fourth antireflective film, and an optical path loss is reduced.

Optionally, when the beam splitter film reflects near-infrared light and transmits visible light, the beam splitter plate further includes a fifth antireflective film. The fifth antireflective film is attached to the second surface of the second transmissive plate, and the fifth antireflective film is configured to increase a transmittance of visible light emergent out of the second transmissive plate from the second surface of the second transmissive plate. When the beam splitter film reflects visible light and transmits near-infrared light, the beam splitter plate further includes a sixth antireflective film. The sixth antireflective film is attached to the second surface of the second transmissive plate, and the sixth antireflective film is configured to increase a transmittance of near-infrared light emergent out of the second transmissive plate from the second surface of the second transmissive plate. In this way, the transmittance when the visible light or the near-infrared light transmitted by the beam splitter film is emergent out of the beam splitter plate is increased by using the fifth antireflective film or the sixth antireflective film, and an optical path loss is reduced.

According to a second aspect, some embodiments of this application provide a beam splitter apparatus. The beam splitter apparatus includes a housing, a connecting structure, and a beam splitter plate. The housing is provided with a light inlet. The connecting structure is disposed on a housing edge at the light inlet, and the connecting structure is configured to connect to an image side end of a lens barrel of an imaging lens module such that the light inlet is opposite to an image side surface of an imaging lens group of the imaging lens module. The beam splitter plate is the beam splitter plate in any technical solution of the first aspect, and the beam splitter plate is disposed obliquely in the housing.

Because the beam splitter plate used in the beam splitter apparatus in this embodiment of this application is the same as the beam splitter plate in any technical solution of the first aspect, the two can resolve a same technical problem and achieve a same expected effect. In addition, because the beam splitter apparatus provided in this embodiment of this application includes the housing and the connecting structure, the housing is provided with the light inlet, the connecting structure is disposed on the housing edge at the light inlet, and the connecting structure can be connected to the image side end of the lens barrel of the imaging lens module such that the light inlet is opposite to the image side surface of the imaging lens group of the imaging lens module, the beam splitter apparatus provided in this embodiment of this application may be connected to a common imaging lens module by using the connecting structure, to assemble a beam splitter lens module, which makes it unnecessary to develop a new beam splitter lens module, thereby saving development costs of the beam splitter lens module.

Optionally, the beam splitter apparatus further includes a visible light sensor and a near-infrared light sensor. The visible light sensor is disposed in the housing, and the visible light sensor is configured to convert visible light reflected or transmitted by the beam splitter plate into a visible light signal. The near-infrared light sensor is disposed in the housing, and the near-infrared light sensor is configured to convert near-infrared light transmitted or reflected by the beam splitter plate into a luminance signal. In this way, the beam splitter plate, the visible light sensor, and the near-infrared light sensor are integrated in the same housing such that accuracy of optical paths from the beam splitter plate to the visible light sensor and from the beam splitter plate to the near-infrared light sensor can be ensured.

Optionally, the beam splitter apparatus further includes a visible light filter, the visible light filter is disposed between the beam splitter plate and the near-infrared light sensor, and the visible light filter is configured to filter out visible light in the near-infrared light reflected or transmitted by the beam splitter plate. In this way, the visible light and the near-infrared light can be further separated, to avoid interference from the visible light to sensing and collection of the near-infrared light.

Optionally, the beam splitter apparatus further includes a near-infrared light filter, the near-infrared light filter is disposed between the beam splitter plate and the visible light sensor, and the near-infrared light filter is configured to filter out near-infrared light in the visible light reflected or transmitted by the beam splitter plate. In this way, the near-infrared light and the visible light can be further separated, to avoid interference from the near-infrared light to sensing and collection of the visible light.

According to a third aspect, some embodiments of this application provide a beam splitter lens module. The beam splitter lens module includes an imaging lens module and a beam splitter apparatus. The imaging lens module includes a lens barrel and an imaging lens group disposed in the lens barrel. The lens barrel has an image side end, the imaging lens group is configured to focus to form an imaging beam, and the imaging lens group has an image side surface. The beam splitter apparatus is the beam splitter apparatus in any technical solution of the second aspect. A housing of the beam splitter apparatus is connected to the image side end of the lens barrel by using a connecting structure, and a light inlet of the beam splitter apparatus is opposite to the image side surface of the imaging lens group.

Because the beam splitter apparatus used in the beam splitter lens module in this embodiment of this application is the same as the beam splitter apparatus in any technical solution of the second aspect, the two can resolve a same technical problem and achieve a same expected effect.

According to a fourth aspect, some embodiments of this application provide a beam splitter lens module. The beam splitter lens module includes a lens barrel, an imaging lens group, and a beam splitter plate. The imaging lens group is disposed in the lens barrel, and the imaging lens group is configured to focus to form an imaging beam. The beam splitter plate is the beam splitter plate in any technical solution of the first aspect, the beam splitter plate is located on an image side of the imaging lens group, and the beam splitter plate is disposed obliquely in the lens barrel.

Because the beam splitter plate used in the beam splitter lens module in this embodiment of this application is the same as the beam splitter plate in any technical solution of the first aspect, the two can resolve a same technical problem and achieve a same expected effect. In addition, the imaging lens group and the beam splitter plate are integrated into the lens barrel such that relative position accuracy between the imaging lens group and the beam splitter plate can be ensured, and accuracy of an optical path from the imaging lens group to the beam splitter plate can be ensured.

Optionally, a first opening is enclosed by an image side end of the lens barrel, and visible light or near-infrared light transmitted by the beam splitter plate is emergent from the first opening. A second opening is provided on a side wall of the lens barrel, and near-infrared light or visible light reflected by the beam splitter plate is emergent from the second opening. The beam splitter lens module further includes a visible light sensor and a near-infrared light sensor. The visible light sensor is disposed outside the lens barrel and fixed to the lens barrel, and the visible light sensor is configured to convert the visible light reflected or transmitted by the beam splitter plate into a visible light signal. The near-infrared light sensor is disposed outside the lens barrel and fixed to the lens barrel, and the near-infrared light sensor is configured to convert the near-infrared light transmitted or reflected by the beam splitter plate into a luminance signal. In this way, the beam splitter plate, the visible light sensor, and the near-infrared light sensor are fixed together such that accuracy of optical paths from the beam splitter plate to the visible light sensor and from the beam splitter plate to the near-infrared light sensor can be ensured.

Optionally, the beam splitter lens module further includes a visible light filter, the visible light filter is disposed between the beam splitter plate and the near-infrared light sensor, and the visible light filter is configured to filter out visible light in the near-infrared light reflected or transmitted by the beam splitter plate. In this way, the visible light and the near-infrared light can be further separated, to avoid interference from the visible light to sensing and collection of the near-infrared light.

Optionally, the beam splitter lens module further includes a near-infrared light filter, the near-infrared light filter is disposed between the beam splitter plate and the visible light sensor, and the near-infrared light filter is configured to filter out near-infrared light in the visible light reflected or transmitted by the beam splitter plate. In this way, the near-infrared light and the visible light can be further separated, to avoid interference from the near-infrared light to sensing and collection of the visible light.

According to a fifth aspect, some embodiments of this application provide a camera. The camera includes the beam splitter lens module in any technical solution of the third aspect or the fourth aspect.

Because the beam splitter lens module used in the camera in this embodiment of this application is the same as the beam splitter lens module in any technical solution of the third aspect or the fourth aspect, the two can resolve a same technical problem and achieve a same expected effect.

According to a sixth aspect, some embodiments of this application provide an electronic device. The electronic device includes the camera in the fifth aspect.

Because the camera used in the electronic device in this embodiment of this application is the same as the camera in the fifth aspect, the two can resolve a same technical problem and achieve a same expected effect.

### BRIEF DESCRIPTION OF DRAWINGS

FIG. 1 is a diagram of an imaging beam path of a camera according to some embodiments of this application;

FIG. 2 is a schematic diagram of a structure of a beam splitter structure of a camera according to some embodiments of this application;

FIG. 3 is a schematic diagram of a structure of a beam splitter structure of a camera according to some other embodiments of this application;

FIG. 4 is a schematic diagram of a structure of a beam splitter structure of a camera according to some other embodiments of this application;

FIG. 5 is a schematic diagram of a structure of a camera according to some embodiments of this application;

FIG. 6 is a schematic diagram of a structure of a beam splitter lens module according to some embodiments of this application;

FIG. 7 is a cutaway drawing of an imaging lens module of the beam splitter lens module shown in FIG. 6;

FIG. 8 is a cutaway drawing of a beam splitter apparatus of the beam splitter lens module shown in FIG. 6;

FIG. 9 is a schematic diagram of a structure of a beam splitter plate according to some embodiments of this application;

FIG. 10 is a schematic diagram of a structure of a beam splitter plate according to some other embodiments of this application;

FIG. 11 is a schematic diagram of a structure of a beam splitter plate according to some other embodiments of this application;

FIG. 12 is a schematic diagram of a structure of a beam splitter plate according to some other embodiments of this application;

FIG. 13 is a schematic diagram of a structure of a beam splitter plate according to some other embodiments of this application;

FIG. 14 is a schematic diagram of a structure of a beam splitter plate according to some other embodiments of this application;

FIG. 15 is a schematic diagram of a structure of a beam splitter plate according to some other embodiments of this application;

FIG. 16 is a schematic diagram of a structure of a beam splitter plate according to some other embodiments of this application;

FIG. 17 is a schematic diagram of a structure of a beam splitter plate according to some other embodiments of this application;

FIG. 18 is a cutaway drawing of the beam splitter lens module shown in FIG. 6;

FIG. 19 is a schematic diagram of a structure of a beam splitter lens module according to some other embodiments of this application;

FIG. 20 is a cutaway drawing of the beam splitter lens module shown in FIG. 19; and

FIG. 21 is a cutaway drawing of a structure of a beam splitter lens module according to some other embodiments of this application.

### REFERENCE SIGNS

01: imaging lens module; 02: beam splitter structure; 021: first right angle prism; 0211: first right angle surface; 0212: second right angle surface; 0213: first inclined surface; 022: second right angle prism; 0221: third right angle surface; 0222: fourth right angle surface; 0223: second inclined surface; 023: beam splitter film; 03: visible light sensor; 04: near-infrared light sensor; 05: image fusion module; 1: beam splitter lens module; 11: imaging lens module; 111: lens barrel; 112: imaging lens group; 12: beam splitter apparatus; 121: housing; 122: connecting structure; 10: beam splitter plate; 101: transmissive plate; 1011: first surface; 1012: second surface; 101a: first transmissive plate; 1011a: first surface; 1012a: second surface; 101b: second transmissive plate; 1011b: first surface; 1012b: second surface; 102: beam splitter film; 103: first antireflective film; 104: second antireflective film; 105: third antireflective film; 106: fourth antireflective film; 107: fifth antireflective film; 108: sixth antireflective film; 123: visible light sensor; 124: near-infrared light sensor; and 2: camera host.

### DESCRIPTION OF EMBODIMENTS

The terms “first” and “second” in the embodiments of this application are merely intended for a purpose of description, and shall not be understood as an indication or implication of relative importance or implicit indication of a quantity of indicated technical features. Therefore, a feature limited by “first” or “second” may explicitly or implicitly include one or more features.

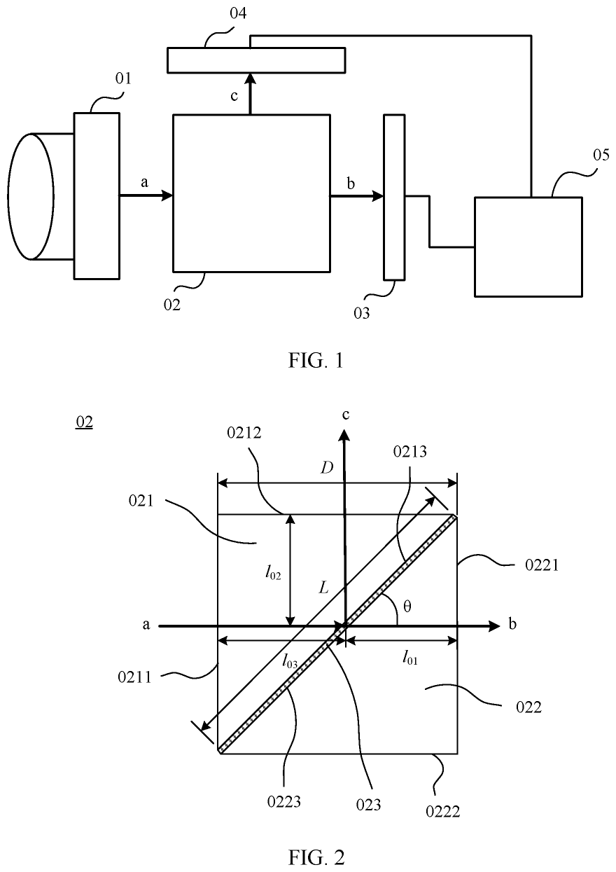

FIG. 1 is a diagram of an imaging beam path of a camera according to some embodiments of this application. The camera is a low-illumination camera, and the camera can output a color image. As shown in FIG. 1, an imaging lens module 01 focuses and forms an imaging beam a. The imaging beam a is incident into a beam splitter structure 02, and is split into visible light b and near-infrared light c by the beam splitter structure 02. The visible light b is incident into a visible light sensor 03, and the visible light sensor 03 converts the visible light b into a visible light signal. The near-infrared light c is incident into a near-infrared light sensor 04, and the near-infrared light sensor 04 converts the near-infrared light c into a luminance signal. Both the visible light sensor 03 and the near-infrared light sensor 04 are connected to an image fusion module 05, and the image fusion module 05 separately processes the visible light signal and the luminance signal, and fuses a processed visible light signal and a processed luminance signal.

It can be learned from FIG. 1 that the beam splitter structure 02 is located in a transmission path of the imaging beam of the camera. FIG. 2 is a schematic diagram of a structure of the beam splitter structure 02 according to some embodiments of this application. As shown in FIG. 2, the beam splitter structure 02 includes a beam splitter film 023, and a first right angle prism 021 and a second right angle prism 022 that are configured to support the beam splitter film 023. The first right angle prism 021 has a first right angle surface 0211, a second right angle surface 0212, and a first inclined surface 0213. The second right angle prism 022 has a third right angle surface 0221, a fourth right angle surface 0222, and a second inclined surface 0223. The first inclined surface 0213 and the second inclined surface 0223 are disposed in parallel and opposite to each other, and the beam splitter film 023 is sandwiched between the first inclined surface 0213 and the second inclined surface 0223. The imaging beam a focused by the imaging lens module is incident into the beam splitter structure 02 from the first right angle surface 0211 along a direction perpendicular to the first right angle surface 0211. After the visible light b and the near-infrared light c in the imaging beam a are separated by the beam splitter film 023, the visible light b is emergent out of the beam splitter structure 02 from the third right angle surface 0221 along a direction perpendicular to the third right angle surface 0221, and the near-infrared light c is emergent out of the beam splitter structure 02 from the second right angle surface 0212.

When an inclination angle θ of the beam splitter film 023 is equal to 45°, as shown in FIG. 2, the separated near-infrared light c is emergent out of the beam splitter structure 02 from the second right angle surface 0212 along a direction perpendicular to the second right angle surface 0212. A transmission path length l₀₂ of the separated near-infrared light c in the first right angle prism 021 is equal to a transmission path length l₀₁ of the separated visible light b in the second right angle prism 022.

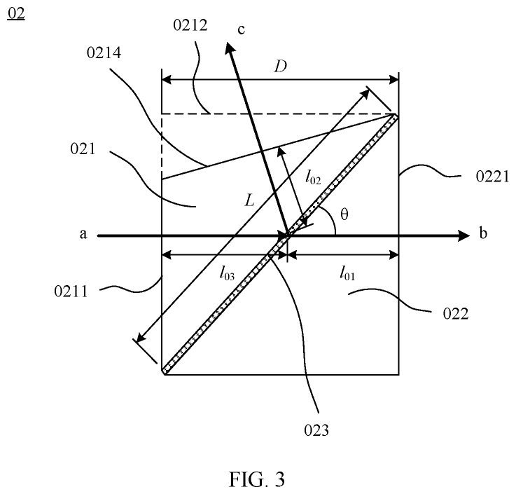

When the inclination angle θ of the beam splitter film 023 is greater than 45°, as shown in FIG. 3, a part that is of the first right angle prism 021 and that is adjacent to the second right angle surface 0212 is cut off, and the part cut off is a part enclosed by a dashed line shown in FIG. 3. In this way, the separated near-infrared light c can be emergent out of the beam splitter structure 02 from a surface 0214 formed after the cutting and along a direction perpendicular to the surface 0214, and a transmission path length l₀₂ of the separated near-infrared light c in the first right angle prism 021 is equal to a transmission path length l₀₁ of the separated visible light b in the second right angle prism 022.

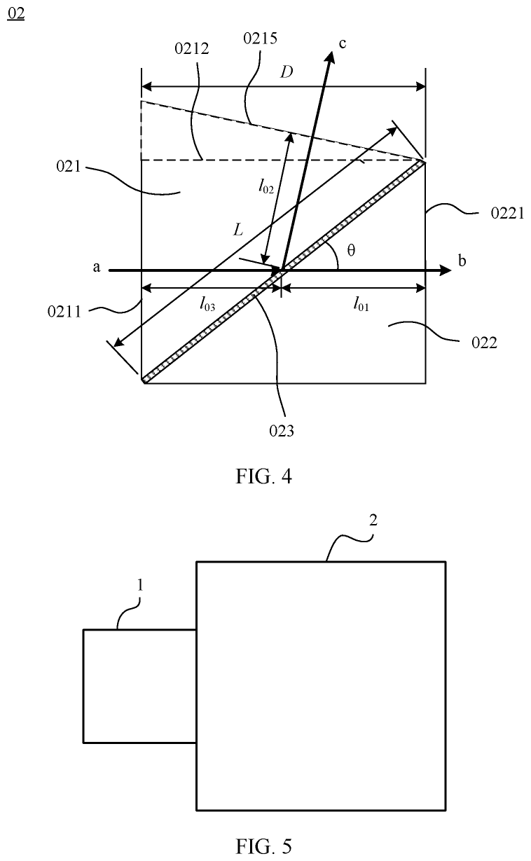

When the inclination angle θ of the beam splitter film 023 is less than 45°, as shown in FIG. 4, a region that is on the first right angle prism 021 and that is adjacent to the second right angle surface 0212 is supplemented with a part of a prism, and the supplementary part is a part enclosed by a dashed line shown in FIG. 4. In this way, the separated near-infrared light c can be emergent out of the beam splitter structure 02 from a surface 0215 formed after the supplementation and along a direction perpendicular to the surface 0215, and a transmission path length l₀₂ of the separated near-infrared light c in the first right angle prism 021 is equal to a transmission path length l₀₁ of the separated visible light b in the second right angle prism 022.

In the embodiment shown in FIG. 2, FIG. 3, or FIG. 4, a transmission path length of the visible light in the imaging beam a in the beam splitter structure 02 is L₀₁=l₀₃+l₀₁=D=L×cos θ. A transmission path length of the near-infrared light in the imaging beam a in the beam splitter structure 02 is L₀₂=l₀₃+l₀₂=l₀₃+l₀₁=D=L×cos θ. It can be learned from above that L₀₁=L₀₂, and both L₀₁ and L₀₂ are equal to a projection length of the beam splitter film 023 on an optical axis of the imaging beam a. l₀₃ is a transmission path length of the imaging beam a in the first right angle prism 021 before the imaging beam a is incident into the beam splitter film 023. D is a thickness of the beam splitter structure 02 along the optical axis direction of the imaging beam. To ensure that the first right angle prism 021 and the second right angle prism 022 can be obtained by processing, a dimension of D is usually in centimeters. L is a width of the beam splitter film 023 in an inclination direction of itself. L×cos θ represents the projection length of the beam splitter film 023 on the optical axis of the imaging beam a. An optical path of the visible light in the imaging beam a in the beam splitter structure 02 is D₀₁=n₀×L₀₁. An optical path of the near-infrared light in the imaging beam a in the beam splitter structure 02 is D₀₂=n₀×L₀₂. A material of the first right angle prism 021 is the same as a material of the second right angle prism 022, and n₀ is a refractive index of the material of the first right angle prism 021 or the second right angle prism 022. The visible light and the near-infrared light in the imaging beam a have relatively long optical paths when transmitted in the beam splitter structure 02, which causes a relatively large chromatic aberration and off-axis aberration, and make it relatively difficult to correct a chromatic aberration and an off-axis aberration of the camera.

To resolve the foregoing problem, this application provides an electronic device. The electronic device includes but is not limited to a mobile phone terminal, an in-vehicle terminal, and a smart wearable device, the electronic device includes a camera, and the camera is a low-illumination camera that can output a color image.

This application provides a camera. FIG. 5 is a schematic diagram of a structure of a camera according to some embodiments of this application. As shown in FIG. 5, the camera includes a beam splitter lens module 1. The beam splitter lens module 1 is configured to focus to form an imaging beam, and split the imaging beam into visible light and near-infrared light.

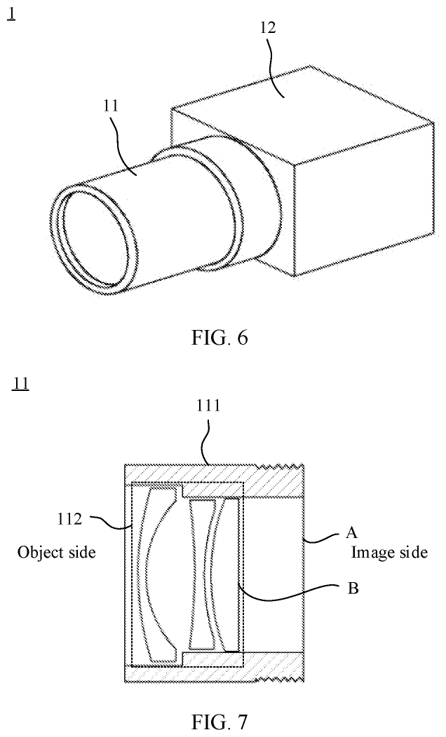

FIG. 6 is a schematic diagram of a structure of the beam splitter lens module 1 according to some embodiments of this application. As shown in FIG. 6, the beam splitter lens module 1 includes an imaging lens module 11 and a beam splitter apparatus 12. The imaging lens module 11 is configured to focus to form an imaging beam. The imaging lens module 11 may be a common C/CS lens module with a relatively long back focal length, or may be a fixed-focus or zoom lens module. This is not specifically limited herein. The beam splitter apparatus 12 is configured to split the imaging beam formed by focusing by the imaging lens module 11 into visible light and near-infrared light.

FIG. 7 is a cutaway drawing of the imaging lens module of the beam splitter lens module shown in FIG. 6. As shown in FIG. 7, the imaging lens module 11 includes a lens barrel 111 and an imaging lens group 112 disposed in the lens barrel 111. The lens barrel 111 is configured to fix the imaging lens group 112. A material of the lens barrel 111 includes but is not limited to metal and plastic. The lens barrel 111 has an image side end A, and the image side end A is an end that is of the lens barrel 111 and that is close to an image side. The imaging lens group 112 includes at least one lens, the imaging lens group 112 is configured to focus to form an imaging beam, the imaging lens group 112 has an image side surface B, and the image side surface B is a surface that is of the imaging lens group 112 and that faces the image side.

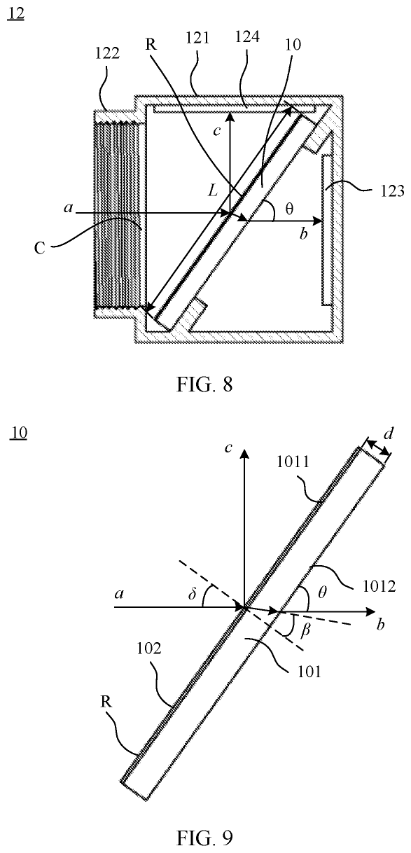

FIG. 8 is a cutaway drawing of the beam splitter apparatus of the beam splitter lens module shown in FIG. 6. As shown in FIG. 8, the beam splitter apparatus 12 includes a housing 121, a connecting structure 122, and a beam splitter plate 10. A material of the housing 121 includes but is not limited to metal and plastic, and the housing 121 is provided with a light inlet C. The connecting structure 122 is disposed on a housing edge at the light inlet C, and the connecting structure 122 includes but is not limited to a screw thread and a buckle. The beam splitter plate 10 is disposed obliquely in the housing 121, and the beam splitter plate 10 can separate visible light from near-infrared light in an imaging beam incident from the light inlet C.

An embodiment of this application provides a beam splitter plate 10. The beam splitter plate 10 includes a transmissive plate and a beam splitter film. The transmissive plate is a light-transmitting plate-like structure. The beam splitter film is supported on the transmissive plate and is parallel to the transmissive plate. The beam splitter film is configured to reflect visible light and transmit near-infrared light, or the beam splitter film is configured to reflect near-infrared light and transmit visible light. A thickness d of the transmissive plate satisfies that when the beam splitter plate is disposed obliquely in a transmission path of the imaging beam of the camera, transmission path lengths of visible light and near-infrared light in the imaging beam in the transmissive plate are both less than a projection length of the beam splitter film on an optical axis of the imaging beam.

In the beam splitter plate provided in this embodiment of this application, because the beam splitter film is configured to reflect visible light and transmit near-infrared light, or the beam splitter film is configured to reflect near-infrared light and transmit visible light, visible light and near-infrared light in an imaging beam path can be separated by using the beam splitter film. Moreover, the beam splitter film is supported on the transmissive plate and is parallel to the transmissive plate, and the thickness d of the transmissive plate satisfies that when the beam splitter plate is disposed obliquely in the transmission path of the imaging beam of the camera, the transmission path lengths of the visible light and the near-infrared light in the imaging beam in the transmissive plate are both less than the projection length of the beam splitter film on the optical axis of the imaging beam. Assuming that an inclination angle of the beam splitter plate is θ, and a width of the beam splitter film along an inclination direction of the beam splitter plate is L, the projection length of the beam splitter film on the optical axis of the imaging beam a is L×cos θ. When the beam splitter film is disposed at the same inclination angle in the transmission path of the imaging beam a and supported by two right angle prisms, as shown in FIG. 2, FIG. 3, or FIG. 4, transmission path lengths of the visible light and the near-infrared light in the imaging beam in the two right angle prisms are L₀₁ and L₀₂, L₀₁=L₀₂, and L₀₁ and L₀₂ are both equal to L×cos θ. It can be learned from above that the transmission path lengths of the visible light and the near-infrared light in the imaging beam are both less than L₀₁ or L₀₂. When a material used for the beam splitter plate is the same as the material of the first right angle prism 021 or the second right angle prism 022 in the embodiment shown in FIG. 2, FIG. 3, or FIG. 4, the visible light and the near-infrared light in the imaging beam have relatively short optical paths when transmitted in the transmissive plate, which causes a relatively small chromatic aberration and off-axis aberration, and helps reduce difficulty in correcting a chromatic aberration and an off-axis aberration of the camera.

It should be noted that, in the description of this embodiment of this application, because a thickness of the beam splitter film is very small, the thickness of the beam splitter film is ignored.

Specifically, FIG. 9 is a schematic diagram of a structure of a beam splitter plate 10 according to some embodiments of this application. As shown in FIG. 9, the beam splitter plate 10 includes a transmissive plate 101 and a beam splitter film 102. A material of the transmissive plate 101 includes but is not limited to optical glass. The transmissive plate 101 has a first surface 1011 and a second surface 1012 opposite to each other, and the first surface 1011 and the second surface 1012 are perpendicular to a thickness direction of the transmissive plate 101. The beam splitter film 102 is disposed on the first surface 1011. The structure is simple and is easy to implement.

When the beam splitter plate 10 described in the foregoing embodiment is mounted in the imaging beam path, and the imaging beam a is incident from a surface that is on the beam splitter film 102 and that is in a direction away from the transmissive plate 101 (that is, a light receiving surface R of the beam splitter plate 10), as shown in FIG. 9, the imaging beam a is incident into the beam splitter plate 10 from the light receiving surface R. The beam splitter film 102 reflects one (for example, near-infrared light c) of the near-infrared light and the visible light in the imaging beam, and transmits the other (for example, visible light b) of the near-infrared light and the visible light. The near-infrared light c does not pass through the transmissive plate 101, and a transmission path length of the near-infrared light c in the beam splitter plate 10 is L₂=0. The visible light b passes through the beam splitter plate 10, and a transmission path length of the visible light b in the beam splitter plate 10 is L₁=d/cos β. According to a light refraction law, n=sin δ/sin β. δ=90°−θ can be learned from FIG. 9. L₁=d×n/sin θ can be deduced from that. n is a refractive index of the material of the transmissive plate 101. Because the thickness d of the transmissive plate 101 satisfies that the transmission path lengths of the visible light and the near-infrared light in the imaging beam a are both less than the projection length of the beam splitter film 102 on the optical axis of the imaging beam a, and the projection length of the beam splitter film 102 on the optical axis of the imaging beam a is L×cos θ, L₁=d×n/sin θ<L×cos θ, and L₂=0<L×cos θ, from which d<L sin θ cos θ/n can be deduced. Therefore, in the embodiment shown in FIG. 9, the thickness d of the transmissive plate 101 satisfies that the transmission path lengths of the visible light and the near-infrared light in the imaging beam a are both less than the projection length of the beam splitter film 102 on the optical axis of the imaging beam a, that is, the thickness d of the transmissive plate 101 satisfies d<L sin θ cos θ/n.

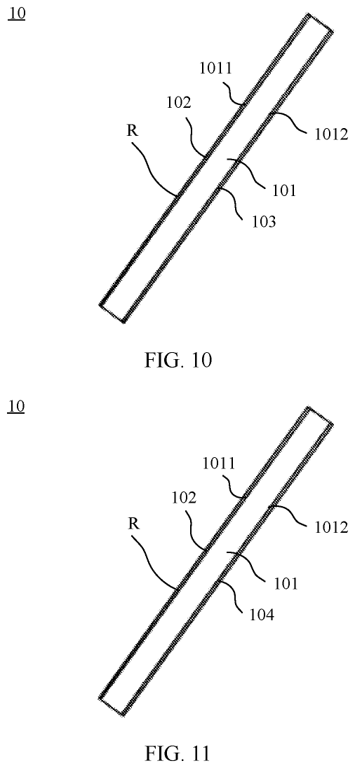

When the beam splitter film 102 is configured to reflect near-infrared light and transmit visible light, to increase a transmittance of the visible light at the second surface 1012 of the transmissive plate 101, in some embodiments, as shown in FIG. 10, the beam splitter plate 10 further includes a first antireflective film 103. The first antireflective film 103 is attached to the second surface 1012. The first antireflective film 103 is configured to increase a transmittance of visible light emergent out of the transmissive plate 101 from the second surface 1012, and the transmitted visible light passes through the first antireflective film 103.

When the beam splitter film 102 is configured to reflect visible light and transmit near-infrared light, to increase a transmittance of the near-infrared light at the second surface 1012 of the transmissive plate 101, in some embodiments, as shown in FIG. 11, the beam splitter plate 10 further includes a second antireflective film 104. The second antireflective film 104 is attached to the second surface 1012. The second antireflective film 104 is configured to increase a transmittance of near-infrared light emergent out of the transmissive plate 101 from the second surface 1012, and the transmitted near-infrared light passes through the second antireflective film 104.

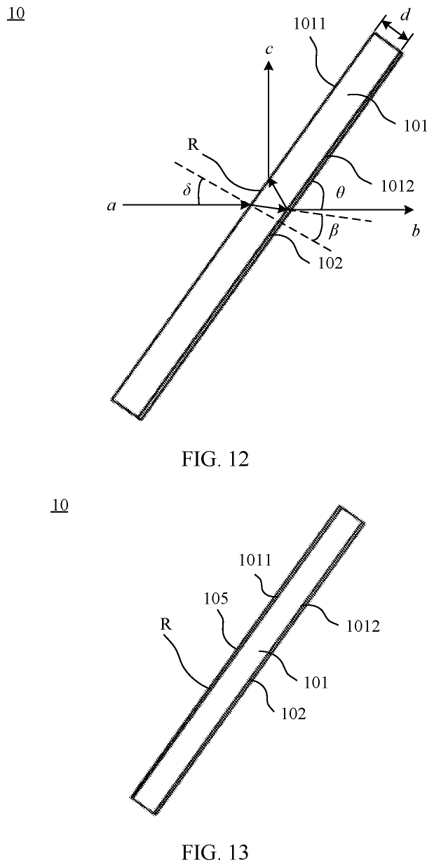

FIG. 12 is a schematic diagram of a structure of a beam splitter plate 10 according to some other embodiments of this application. As shown in FIG. 12, the beam splitter plate 10 includes a transmissive plate 101 and a beam splitter film 102. A material of the transmissive plate 101 includes but is not limited to optical glass. The transmissive plate 101 has a first surface 1011 and a second surface 1012 opposite to each other, and the first surface 1011 and the second surface 1012 are perpendicular to a thickness direction of the transmissive plate 101. The beam splitter film 102 is attached to the second surface 1012. The structure is simple and is easy to implement.

When the beam splitter plate 10 described in the foregoing embodiment is mounted in the imaging beam path, and the imaging beam a is incident from the first surface 1011 (that is, a light receiving surface R of the beam splitter plate 10), as shown in FIG. 12, the imaging beam a is incident into the beam splitter plate 10 from the light receiving surface R. The beam splitter film 102 reflects one (for example, near-infrared light c) of the near-infrared light and the visible light in the imaging beam, and transmits the other (for example, visible light b) of the near-infrared light and the visible light. The near-infrared light c passes through the transmissive plate 101 twice, and a transmission path length of the near-infrared light c in the beam splitter plate 10 is L₂=2×d/cos β. The visible light b passes through the beam splitter plate 10 once, and a transmission path length of the visible light b in the beam splitter plate 10 is L₁=d/cos β. According to a light refraction law, n=sin δ/sin β. δ=90°−θ can be learned from FIG. 9. L₁=d×n/sin θ and L₂=2×d×n/sin θ can be deduced from that. n is a refractive index of the material of the transmissive plate 101. Because the thickness d of the transmissive plate 101 satisfies that the transmission path lengths of the visible light and the near-infrared light in the imaging beam a are both less than the projection length of the beam splitter film 102 on the optical axis of the imaging beam a, and the projection length of the beam splitter film 102 on the optical axis of the imaging beam a is L×cos θ, L₁=d×n/sin θ<L×cos θ, and L₂=2×d×n/sin θ<L×cos θ, from which d<L sin θ cos θ/2n can be deduced. Therefore, in the embodiment shown in FIG. 12, the thickness d of the transmissive plate 101 satisfies that the transmission path lengths of the visible light and the near-infrared light in the imaging beam a are both less than the projection length of the beam splitter film 102 on the optical axis of the imaging beam a, that is, the thickness d of the transmissive plate 101 satisfies d<L sin θ cos θ/2n.

To increase transmittances of visible light and near-infrared light at the first surface 1011 of the transmissive plate 101, in some embodiments, as shown in FIG. 13, the beam splitter plate 10 further includes a third antireflective film 105. The third antireflective film 105 is attached to the first surface 1011. The third antireflective film 105 is configured to increase transmittances of visible light and near-infrared light that are incident into the transmissive plate 101 from the first surface 1011, and the visible light and the near-infrared light in the imaging beam pass through the third antireflective film 105.

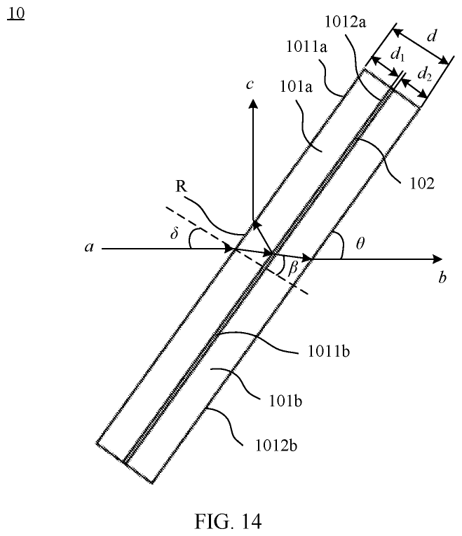

FIG. 14 is a schematic diagram of a structure of a beam splitter plate 10 according to some other embodiments of this application. As shown in FIG. 14, the beam splitter plate 10 includes a first transmissive plate 101a, a second transmissive plate 101b, and a beam splitter film 102. Materials of the first transmissive plate 101a and the second transmissive plate 101b include but are not limited to optical glass. The first transmissive plate 101a has a first surface 1011a and a second surface 1012a opposite to each other, and the first surface 1011a and the second surface 1012a are perpendicular to a thickness direction of the first transmissive plate 101a. The second transmissive plate 101b has a first surface 1011b and a second surface 1012b opposite to each other, and the first surface 1011b and the second surface 1012b are perpendicular to a thickness direction of the second transmissive plate 101b. The beam splitter film 102 is sandwiched between the second surface 1012a and the first surface 1011b. The beam splitter film 102 is configured to reflect visible light and transmit near-infrared light, or the beam splitter film 102 is configured to reflect near-infrared light and transmit visible light. The structure is simple and easy to implement, and can perform waterproof and dustproof protection on the beam splitter film.

When the beam splitter plate 10 described in the foregoing embodiment is mounted in the imaging beam path, and the imaging beam a is incident from the first surface 1011a (that is, a light receiving surface R of the beam splitter plate 10), as shown in FIG. 14, the imaging beam a is incident into the beam splitter plate 10 from the light receiving surface R. The beam splitter film 102 reflects one (for example, near-infrared light c) of the near-infrared light and the visible light in the imaging beam, and transmits the other (for example, visible light b) of the near-infrared light and the visible light. The near-infrared light c passes through the first transmissive plate 101a twice, and a transmission path length of the near-infrared light c in the beam splitter plate 10 is L₂=2×d₁/cos β. The visible light b passes through the first transmissive plate 101a and the second transmissive plate 101b, and a transmission path length of the visible light b in the beam splitter plate 10 is L₁=(d₁+d₂)/cos β=d/cos β. According to a light refraction law, n=sin δ/sin β. δ=90°−θ can be learned from FIG. 9. L₁=d×n/sin θ and L₂=2×d₁×n/sin θ can be deduced from that. n is a refractive index of the material of the transmissive plate 101. d₁ is a thickness of the first transmissive plate 101a. d₂ is a thickness of the second transmissive plate 101b. Because the thickness d of the transmissive plate 101 satisfies that the transmission path lengths of the visible light and the near-infrared light in the imaging beam a are both less than the projection length of the beam splitter film 102 on the optical axis of the imaging beam a, and the projection length of the beam splitter film 102 on the optical axis of the imaging beam a is L×cos θ, L₁=d×n/sin θ <L×cos θ, and L₂=2×d₁×n/sin θ<L×cos θ, from which d<L sin θ cos θ/n and d₁≤d₂ can be deduced. Therefore, in the embodiment shown in FIG. 14, the thickness d of the transmissive plate 101 satisfies that the transmission path lengths of the visible light and the near-infrared light in the imaging beam a are both less than the projection length of the beam splitter film 102 on the optical axis of the imaging beam a, that is, the thickness d of the transmissive plate 101 satisfies d<L sin θ cos θ/n and d₁≤d₂.

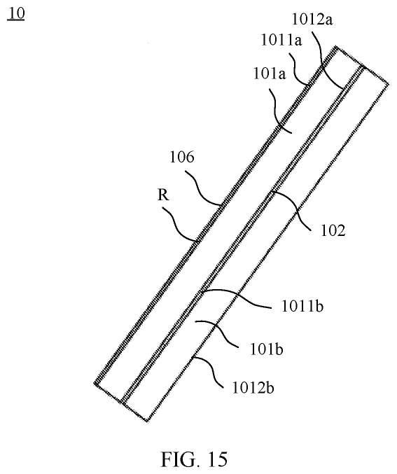

To increase transmittances of visible light and near-infrared light at the first surface 1011a of the first transmissive plate 101a, in some embodiments, as shown in FIG. 15, the beam splitter plate 10 further includes a fourth antireflective film 106. The fourth antireflective film 106 is attached to the first surface 1011a of the first transmissive plate 101a. The fourth antireflective film 106 is configured to increase transmittances of visible light and near-infrared light that are incident into the first transmissive plate 101a from the first surface 1011a of the first transmissive plate 101a, and the visible light and the near-infrared light in the imaging beam pass through the fourth antireflective film 106.

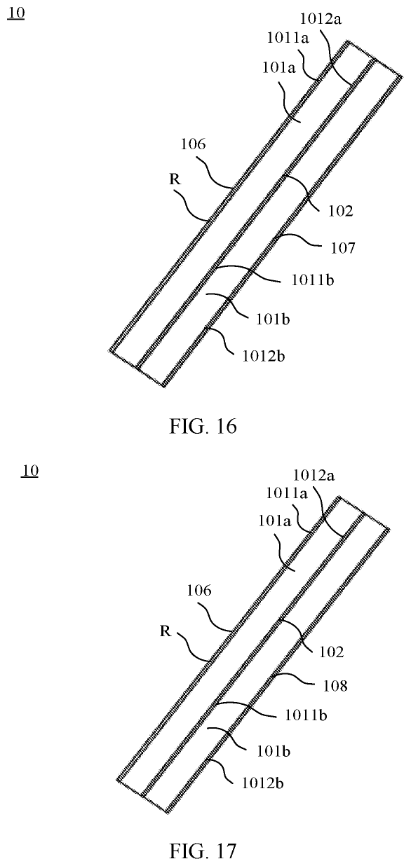

When the beam splitter film 102 is configured to reflect near-infrared light and transmit visible light, to increase a transmittance of the visible light at the second surface 1012b of the second transmissive plate 101b, in some embodiments, as shown in FIG. 16, the beam splitter plate 10 further includes a fifth antireflective film 107. The fifth antireflective film 107 is attached to the second surface 1012b of the second transmissive plate 101b. The fifth antireflective film 107 is configured to increase a transmittance of visible light emergent out of the second transmissive plate 101b from the second surface 1012b of the second transmissive plate 101b, and the transmitted visible light passes through the fifth antireflective film 107.

When the beam splitter film 102 is configured to reflect visible light and transmit near-infrared light, to increase a transmittance of the near-infrared light at the second surface 1012b of the second transmissive plate 101b, in some embodiments, as shown in FIG. 17, the beam splitter plate 10 further includes a sixth antireflective film 108. The sixth antireflective film 108 is attached to the second surface 1012b of the second transmissive plate 101b. The sixth antireflective film 108 is configured to increase a transmittance of near-infrared light emergent out of the second transmissive plate 101b from the second surface 1012b of the second transmissive plate 101b, and the transmitted near-infrared light passes through the sixth antireflective film 108.

In some embodiments, the thickness d of the transmissive plate 101 is less than 0.5 mm. In this way, the thickness of the transmissive plate 101 is relatively small, and when the beam splitter plate 10 is disposed obliquely in the transmission path of the imaging beam of the camera, the transmission path lengths of the visible light b and the near-infrared light c in the imaging beam a in the transmissive plate 101 are relatively small, which causes a relatively small chromatic aberration and off-axis aberration, and reduces difficulty in correcting a chromatic aberration and an off-axis aberration of the camera.

In some embodiments, the inclination angle θ of the beam splitter plate 10 is 40° to 60°. When the inclination angle of the beam splitter plate 10 is within this range, visible light and near-infrared light can be separated.

In some embodiments, as shown in FIG. 8, the beam splitter apparatus 12 further includes a visible light sensor 123 and a near-infrared light sensor 124. The visible light sensor 123 is disposed in the housing 121, and the visible light sensor 123 is configured to convert the visible light b reflected or transmitted by the beam splitter plate 10 into a visible light signal. The near-infrared light sensor 124 is disposed in the housing 121, and the near-infrared light sensor 124 is configured to convert the near-infrared light c transmitted or reflected by the beam splitter plate 10 into a luminance signal.

In this way, the beam splitter plate 10, the visible light sensor 123, and the near-infrared light sensor 124 are integrated in the same housing such that accuracy of optical paths from the beam splitter plate 10 to the visible light sensor 123 and from the beam splitter plate 10 to the near-infrared light sensor 124 can be ensured.

In some embodiments, the beam splitter apparatus 12 further includes a visible light filter (not shown in the figure), the visible light filter is disposed between the beam splitter plate 10 and the near-infrared light sensor 124, and the visible light filter is configured to filter out visible light in the near-infrared light reflected or transmitted by the beam splitter plate 10. In this way, the visible light and the near-infrared light can be further separated, to avoid interference from the visible light to sensing and collection of the near-infrared light.

In some embodiments, the beam splitter apparatus 12 further includes a near-infrared light filter (not shown in the figure), the near-infrared light filter is disposed between the beam splitter plate 10 and the visible light sensor 123, and the near-infrared light filter is configured to filter out near-infrared light in the visible light reflected or transmitted by the beam splitter plate 10. In this way, the near-infrared light and the visible light can be further separated, to avoid interference from the near-infrared light to sensing and collection of the visible light.

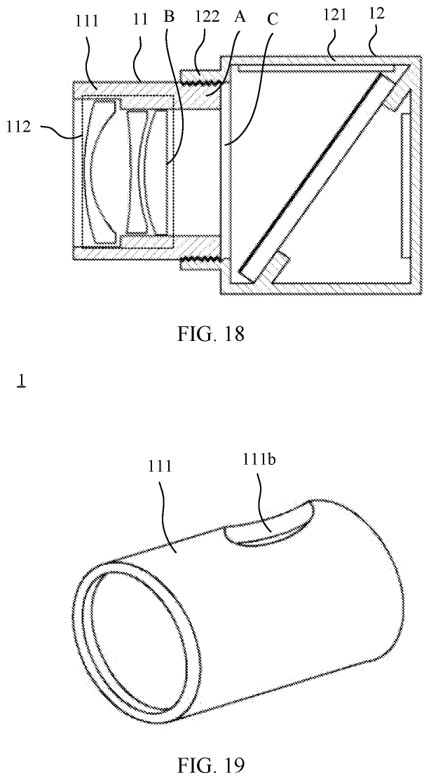

FIG. 18 is a cutaway drawing of the beam splitter lens module shown in FIG. 6. As shown in FIG. 18, the housing 121 of the beam splitter apparatus 12 is connected to the image side end A of the lens barrel 111 of the imaging lens module 11 by using the connecting structure 122, and the light inlet C of the beam splitter apparatus 12 is opposite to the image side surface B of the imaging lens group 112 of the imaging lens module 11. In this way, the beam splitter lens module is assembled, and the beam splitter apparatus can be assembled with different imaging lens modules to form beam splitter lens modules having different functions, which makes it unnecessary to develop a new beam splitter lens module, thereby saving development costs of the beam splitter lens module.

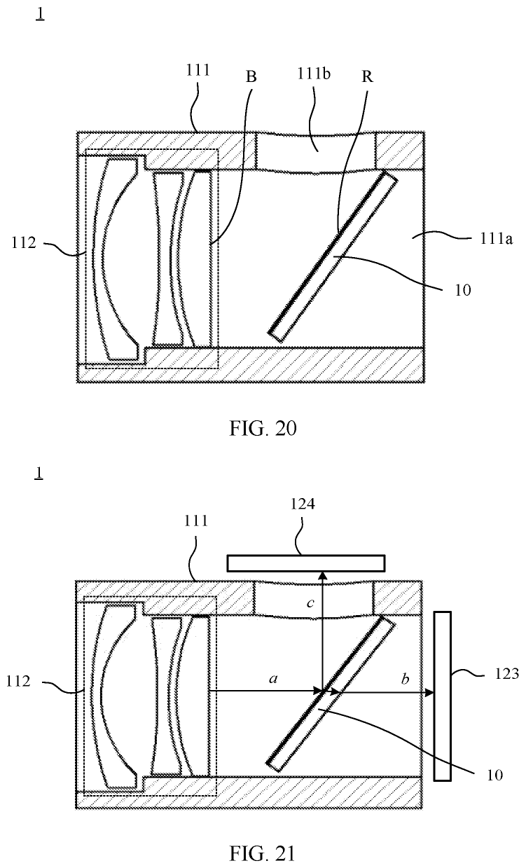

FIG. 19 is a schematic diagram of a structure of a beam splitter lens module 1 according to some other embodiments of this application. FIG. 20 is a cutaway drawing of the beam splitter lens module shown in FIG. 19. As shown in FIG. 19 and FIG. 20, the beam splitter lens module 1 includes a lens barrel 111, an imaging lens group 112, and a beam splitter plate 10. The lens barrel 111 is configured to fix the imaging lens group 112 and the beam splitter plate 10. A material of the lens barrel 111 includes but is not limited to metal and plastic. The imaging lens group 112 is disposed in the lens barrel 111, the imaging lens group 112 includes at least one lens, and the imaging lens group 112 is configured to focus to form an imaging beam. The beam splitter plate 10 is the same as the beam splitter plate 10 in the beam splitter apparatus 12, the beam splitter plate 10 is disposed obliquely in the lens barrel 111, the beam splitter plate 10 is located on an image side of the imaging lens group 112, and a light receiving surface R of the beam splitter plate 10 faces an image side surface B of the imaging lens group.

In this way, the imaging lens group 112 and the beam splitter plate 10 are integrated into the lens barrel 111 such that relative position accuracy between the imaging lens group 112 and the beam splitter plate 10 can be ensured, and accuracy of an optical path from the imaging lens group 112 to the beam splitter plate 10 can be ensured.

In some embodiments, as shown in FIG. 19 and FIG. 20, a first opening 111a is enclosed by an image side end of the lens barrel 111, and visible light or near-infrared light transmitted by the beam splitter plate 10 can be emergent from the first opening 111a. A second opening 111b is provided on a side wall of the lens barrel 111, and near-infrared light or visible light reflected by the beam splitter plate 10 can be emergent from the second opening 111b.

In some embodiments, as shown in FIG. 21, the beam splitter lens module 1 further includes a visible light sensor 123 and a near-infrared light sensor 124. The visible light sensor 123 is disposed outside the lens barrel 111 and fixed to the lens barrel 111, and the visible light sensor 123 is configured to convert the visible light b reflected or transmitted by the beam splitter plate 10 into a visible light signal. The near-infrared light sensor 124 is disposed outside the lens barrel 111 and fixed to the lens barrel 111, and the near-infrared light sensor 124 is configured to convert the near-infrared light c transmitted or reflected by the beam splitter plate 10 into a luminance signal.

In this way, the beam splitter plate 10, the visible light sensor 123, and the near-infrared light sensor 124 are fixed together such that accuracy of optical paths from the beam splitter plate 10 to the visible light sensor 123 and from the beam splitter plate 10 to the near-infrared light sensor 124 can be ensured.

In some embodiments, the beam splitter lens module 1 further includes a visible light filter (not shown in the figure), the visible light filter is disposed between the beam splitter plate 10 and the near-infrared light sensor 124, and the visible light filter is configured to filter out visible light in the near-infrared light reflected or transmitted by the beam splitter plate 10. In this way, the visible light and the near-infrared light can be further separated, to avoid interference from the visible light to sensing and collection of the near-infrared light.

In some embodiments, the beam splitter lens module 1 further includes a near-infrared light filter (not shown in the figure), the near-infrared light filter is disposed between the beam splitter plate 10 and the visible light sensor 123, and the near-infrared light filter is configured to filter out near-infrared light in the visible light reflected or transmitted by the beam splitter plate 10. In this way, the near-infrared light and the visible light can be further separated, to avoid interference from the near-infrared light to sensing and collection of the visible light.

As shown in FIG. 5, the camera further includes a camera host 2, and the camera host 2 includes an image fusion module (not shown in the figure). The image fusion module is electrically connected to the visible light sensor 123, and the image fusion module is electrically connected to the near-infrared light sensor 124. The image fusion module is configured to perform separate image processing on the visible light signal converted by the visible light sensor 123 and the luminance signal converted by the near-infrared light sensor 124, and fuse a processed visible light signal and a processed luminance signal.

In the descriptions of this specification, the described specific features, structures, materials, or characteristics may be combined in an appropriate manner in any one or more of the embodiments or examples.

Finally, it should be noted that the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. A beam splitter plate configured to dispose obliquely in a transmission path of an imaging beam of a camera, and comprising:
a transmissive plate; and
a beam splitter film supported on the transmissive plate and parallel to the transmissive plate, wherein the beam splitter film is configured to reflect visible light and transmit near-infrared light, or the beam splitter film is configured to reflect the near-infrared light and transmit the visible light,
wherein a thickness of the transmissive plate satisfies that transmission path lengths of the visible light and the near-infrared light in the imaging beam in the transmissive plate are both less than a projection length of the beam splitter film on an optical axis of the imaging beam.

2. The beam splitter plate of claim 1, wherein the transmissive plate is a light-transmitting plate-like structure.

3. The beam splitter plate of claim 1, wherein the transmissive plate has a first surface and a second surface opposite to each other, and wherein the beam splitter film is attached to the first surface or the second surface.

4. The beam splitter plate of claim 3, further comprising:
a first antireflective film attached to the second surface when the beam splitter film is attached to the first surface and configured to reflect the near-infrared light and transmit the visible light, wherein the first antireflective film is configured to increase a first transmittance of the visible light emergent out of the transmissive plate from the second surface; and
a second antireflective film attached to the second surface when the beam splitter film is attached to the first surface and configured to reflect the visible light and transmit the near-infrared light, wherein the second antireflective film is configured to increase a second transmittance of the near-infrared light emergent out of the transmissive plate.

5. The beam splitter plate of claim 3, further comprising a third antireflective film attached to the first surface when the beam splitter film is attached to the second surface, wherein the third antireflective film is configured to increase transmittances of the visible light and the near-infrared light that are incident into the transmissive plate from the first surface.

6. The beam splitter plate of claim 1, wherein the transmissive plate comprises:
a first transmissive plate comprising a third surface and a fourth surface opposite to each other; and
a second transmissive plate comprising a fifth surface and a sixth surface opposite to each other, wherein the beam splitter film is sandwiched between the fourth surface and the fifth surface.

7. The beam splitter plate of claim 6, further comprising a fourth antireflective film attached to the third surface, wherein the fourth antireflective film is configured to increase transmittances of visible light and near-infrared light that are incident into the first transmissive plate from the third surface.

8. The beam splitter plate of claim 6, further comprising:
a fifth antireflective film attached to the sixth surface when the beam splitter film reflects the near-infrared light and transmits the visible light, wherein the fifth antireflective film is configured to increase a first transmittance of visible light emergent out of the second transmissive plate from the sixth surface; and
a sixth antireflective film attached to the sixth surface when the beam splitter film reflects the visible light and transmits the near-infrared light, wherein the sixth antireflective film is configured to increase a second transmittance of the near-infrared light emergent out of the second transmissive plate from the sixth surface.

9. A beam splitter lens system comprising:
an imaging lens system comprising:
a lens barrel comprising an image side end; and
an imaging lens group disposed in the lens barrel, comprising an image side surface, and configured to focus to form an imaging beam; and
a beam splitter apparatus comprising:
a housing connected to the image side end using a connecting structure; and
a light inlet disposed opposite to the image side surface.

10. The beam splitter lens system of claim 9, wherein the imaging lens system is a common C/CS lens system.

11. The beam splitter lens system of claim 9, wherein the imaging lens system is a fixed-focus lens system.

12. The beam splitter lens system of claim 9, wherein the imaging lens system is a zoom lens system.

13. The beam splitter lens system of claim 9, wherein the beam splitter apparatus further comprises:
a beam splitter plate disposed obliquely in the housing;
a visible light sensor disposed in the housing and configured to convert visible light reflected or transmitted by the beam splitter plate into a visible light signal; and
a near-infrared light sensor disposed in the housing and configured to convert near-infrared light transmitted or reflected by the beam splitter plate into a luminance signal.

14. A beam splitter lens system comprising:
a lens barrel;
an imaging lens group disposed in the lens barrel, comprising an image side, and configured to focus to form an imaging beam; and
a beam splitter plate located on the image side and disposed obliquely in the lens barrel.

15. The beam splitter lens system of claim 14, wherein the lens barrel comprises:
an image side end enclosing a first opening, wherein visible light or near-infrared light transmitted by the beam splitter plate is emergent from the first opening; and
a side wall enclosing a second opening, wherein near-infrared light or visible light reflected by the beam splitter plate is emergent from the second opening.

16. The beam splitter lens system of claim 15, further comprising a visible light sensor disposed outside the lens barrel, fixed to the lens barrel, and configured to convert the visible light reflected or transmitted into a visible light signal.

17. The beam splitter lens system of claim 15, further comprising a near-infrared light sensor disposed outside the lens barrel, fixed to the lens barrel, and configured to convert the near-infrared light reflected or transmitted into a luminance signal.

18. The beam splitter lens system of claim 14, wherein the lens barrel comprises a metal material.

19. The beam splitter lens system of claim 14, wherein the lens barrel comprises a plastic material.

20. The beam splitter lens system of claim 14, wherein the imaging lens group and the beam splitter plate are integrated into the lens barrel.
